(19) United States
(12) Patent Application Publication
(10) Pub. No.: US 2011/0133900 A1
(43) Pub. Date: Jun. 9, 2011

(54) Radio-Based Activation and Deactivation of a Zero-Energy Standby Mode of Automation Systems

(75) Inventors: Jens Kydles, Nurnberg (DE); Jörg Neidig, Nurnberg (DE)

(73) Assignee: Siemens Aktiengesellschaft, Munchen (DE)

(21) Appl. No.: 13/056,865

(22) PCT Filed: Jul. 31, 2008
(86) PCT No.: PCT/EP2008/006323

§ 371 Date: Jan. 31, 2011

(51) Int. Cl. H04Q 5/22

(52) U.S. Cl. 340/10.1

(57) ABSTRACT

A method for radio-based activation and deactivation of a zero-energy standby mode of automation components, wherein a passive unit of the automation component receives a radio signal, energy transmitted with the radio signal is converted into energy for actuating an electronic switch, and the energy supplied to a functional unit of the automation component is interrupted or restored by the actuation of the electronic switch such that the functional unit of the automation component is activated or deactivated.

### CROSS-REFERENCE TO RELATED APPLICATIONS

This is a U.S. national stage of International Application No. PCT/EP2008/006323, filed on 31 Jul. 2008.

### BACKGROUND OF THE INVENTION

1. Field of the Invention

The invention relates to energy management and, more particularly, to a method for radio-based activation and deactivation of zero-energy standby operation of automation components, and to electrical automation components.

2. Description of the Related Art

Automation systems have widely differing automation components for performing automation tasks such as sensors, actuators, or controllers or drives. Like all electrical or electronic appliances, the automation components must be supplied with power to perform their task. With a few exceptions, the power supply for this purpose is generally ensured by cables, radio or batteries. It is desirable for two reasons to reduce the power consumption of the electrical and electronic appliances. On the one hand, increasing energy costs are necessitating more economic electricity consumption and, on the other hand, the maintenance effort for battery-powered components should be kept as low as possible.

In particular, radio-based system components, which are supplied with electricity by a battery, often have only a very restricted duration of operation. Sensor/actuator networks in automation systems are one such radio-based system components.

These comprise a multiplicity of small, intelligent sensor/actuator nodes which are networked with one another, perform complex tasks as a group, and can communicate with one another over a radio link. These components consume energy all the time, except when they are explicitly (manually) deactivated by a switch.

In conventional systems, active radio-based components are generally supplied with electricity through a switch by connection to the power source (i.e., by inserted batteries). Various mechanisms exist for saving energy depending on the connection quality or load level. No standby mode which requires no energy exists for radio-based appliances, such as for appliances which can be controlled remotely by radio, infrared or similar techniques. If the elements are not disconnected from the power source, such as by a switch or the removal of the power source, this results in energy being consumed continuously.

US Publication No. 2007/0205873 A1 describes a method for activation of an RFID tag. Here, a passive RFID tag is activated with the aid of the energy in the radio signal that is sent to the RFID tag. The RFID tag then activates a circuit that can supply power autonomously from a battery. However, the described method allows only the activation of the RFID tag itself.

### SUMMARY OF THE INVENTION

It is therefore an object of the present invention to switch automation components to zero-energy standby operation by radio, and to activate automation components again by radio from zero-energy standby operation.

This and other object and advantages are achieved by a method for radio-based activation and deactivation of zero-energy standby operation of automation components, wherein a passive unit of the automation component receives a radio signal, energy which is transmitted with the radio signal is used to operate an electronic switch, and a power supply to a functional unit of the automation component is interrupted or recreated by the operation of the electronic switch, such that the functional unit of the automation component is activated or deactivated.

The invention is based on the discovery that a passive unit or a passive element, such as an RFID tag, can be addressed by radio and that, in doing so, sufficient energy is transmitted with the radio signal to operate an electronic switch that is coupled to the passive unit. In accordance with the invention, the switch is inserted into a circuit by which a functional unit, which acts as a load, is connected to a power supply such as a battery.

When the switch is now operated by the radio signal, for example, the circuit can be closed or opened, and the power supply from the electricity source, e.g., the battery, for the functional unit of an automation component is interrupted (when the switch is open) or is recreated (when the switch is closed). The functional unit of the automation component can therefore be switched to the standby mode, or can be reactivated again from the standby mode, in a simple manner by transmission of a radio signal. Here, since the switch disconnects the functional unit from the power supply in the standby mode, it is possible to switch to a standby mode in which no energy at all is consumed by the functional unit. Here, the passive unit itself does not require a power supply, as a result of which the entire automation component, with the functional unit and the passive unit, does not consume any energy at all when in the standby mode. The energy required for reactivation can be transmitted exclusively by the radio signal. The actual functional unit is therefore supplied with the energy source after the activation of the passive element and the operation of the switch.

The energy saving in this case is particularly advantageous because no energy at all is consumed any longer by the functional unit during standby operation. Furthermore, this results in an increase in the operating duration when using an internal energy source. The energy of a battery is not consumed as quickly as in the normal case, when an automation component or an electrical appliance in the standby mode nevertheless consumes energy. Furthermore, no manual action is required by a user, since the system can itself specifically switch individual components which are not-in-use to the zero-energy state, and can reactivate the individual components. The automation components are therefore autonomous, and can be installed without the use of cables.

In a further advantageous embodiment of the invention, the power supply is interrupted or recreated by a CMOS switch. A CMOS switch is a semiconductor element which has a particularly low energy threshold to perform switching. The switching process is performed electronically. As a result, there is no mechanical wear.

In a further advantageous embodiment of the invention, the radio signal is received by an RFID tag. Here, it is advantageous that a single standard component, which is provided in any case for reception of radio signals, can be used for wire-free activation and deactivation of the automation components.

In a further advantageous embodiment of the invention, the sensor/actuator nodes of a sensor network are activated and deactivated. Particularly in automation systems in which a large number of sensors are distributed within the installation, and are once again combined to form networks, wiring for the electrical power supply is extremely complex. Sensors such as these are therefore frequently supplied by an autonomous energy source. In order to ensure that the sensors and actuators in the installation have a long life in this case, it is particularly advantageous for it to be possible to switch these automation components to zero-energy standby operation, thus providing a capability to save energy from the power supply, thus leading to the already mentioned advantages of long life, energy saving and little maintenance effort.

In yet a further advantageous embodiment of the invention, a specific signal for activation and deactivation of the functional unit is transmitted with the radio signal. In the present advantageous embodiment, in order to activate and deactivate the automation component, i.e., the functional unit of the automation component, not only must the energy be sufficient to operate the switch, but it is necessary to send a further signal which indicates that a reaction is expected from the automation component, i.e., the functional unit. This ensures that the automation component is not deactivated or activated when power is merely flowing and there is no intention at all for activation or deactivation.

In still a further advantageous embodiment of the invention, an ID is transmitted with the radio signal, and the functional unit is activated or deactivated when the transmitted ID matches an ID of the automation component. This ensures in a simple manner that, in an automation system in which a large number of automation components are activated and deactivated with the aid of the method and a large number of automation components themselves transmit radio signals again, the only automation components which are activated are those which receive a corresponding identification signal or a tag which matches their own. This ensures that automation components can be addressed and activated individually, and that automation components which are not intended to react remain appropriately passive.

In another advantageous embodiment of the invention, the automation component sends and receives data by radio, as soon as the functional unit is active. Consequently, the automation component is activated and deactivated not only by radio signals and the energy transmitted in them, but also uses the radio capability for general communication with other automation components, or with the central controller for the automation system, thus allowing general communication which is based on the same infrastructure as the method for activation and deactivation of the automation component. This minimizes the infrastructure complexity to the greatest possible extent.

In another advantageous embodiment of the invention, a plurality of automation components communicate with one another by radio signals, and the automation components activate and deactivate one another by the radio signals. Activation and deactivation therefore need not be performed from a central point. When the automation components are distributed over a relatively large area within the installation, the automation components autonomously ensure activation and deactivation of adjacent automation components, provided that they are within range of one another for the radio signals.

In yet a further advantageous embodiment of the invention, a plurality of sensor/actuator nodes form a sensor/actuator network. The formation of these networks allows entire groups of automation components in these sensor/actuator nodes of a network to be activated and deactivated in a cascaded form by their adjacent components.

In a further advantageous embodiment of the invention, at least two sensor/actuator networks have different automation tasks, and the functional unit of at least one automation component in the second sensor/actuator network is activated by the reception of a radio signal from an automation component in the first sensor/actuator network. This results in the capability to successively activate different sensor/actuator networks which, for example, have different tasks in a manufacturing installation. For example, one specific automation task can be performed completely first in a sensor network, and the second sensor network will be activated by an automation component, which is located within the first sensor network and receives the information in this sensor network. As a result, the second sensor network can now be activated by the transmission of an appropriate radio signal in an automation component of the second sensor/actuator network. The activation of only one automation component in the second network is then sufficient to once again initiate a chain reaction in the second network, and to activate all of the automation components involved in the network.

The object of the invention is also achieved by an electrical automation component having a passive unit which is intended to receive a radio signal, a functional unit for performing automation functionality, a local power source for supplying the functional unit and an electronic switch, which is arranged between the power source and the functional unit, where the electronic switch is coupled to the passive unit such that energy received by the passive unit with the radio signal leads to operation of the electrical switch, by which the functional unit of the automation component can be activated and deactivated.

The object is also achieved by a system comprising a plurality of sensor/actuator networks, consisting of electrical automation components, where the automation components are intended to communicate with one another by radio signals, and where radio signals are intended for mutual activation and deactivation of the automation components.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described and explained in more detail in the following text with reference to the figures, in which:

FIG. 1 shows a schematic layout of an electrical automation component;

FIG. 2 shows an automation system with two sensor/actuator node networks;

FIG. 3 shows an exemplary schematic block diagram of an electronic switch; and

FIG. 4 shows a flow chart in accordance with en embodiment of the invention.

### DETAILED DESCRIPTION OF THE PREFERRED EMBODIMENTS

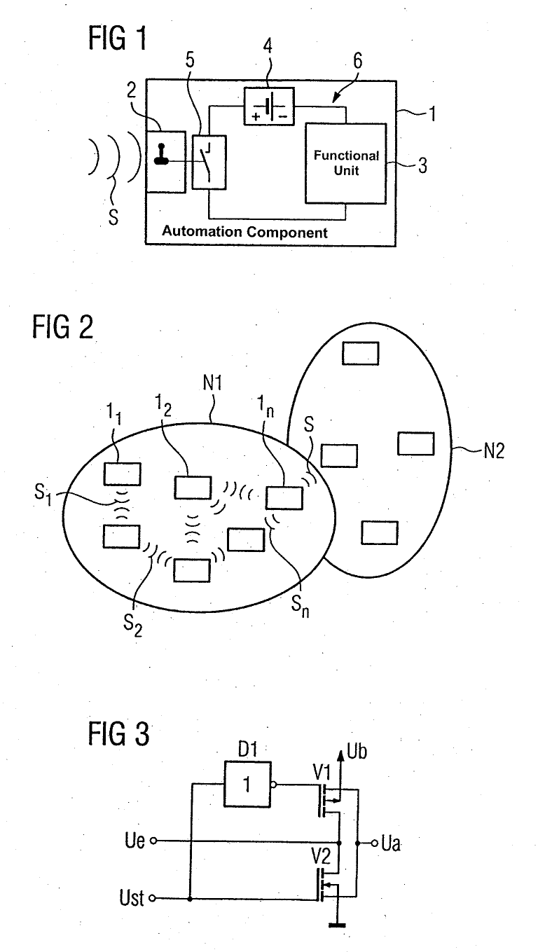

FIG. 1 shows the schematic layout of an electrical automation component 1. The automation component has a functional unit 3 and a passive unit 2. The functional unit is intended to perform automation tasks. By way of example, the functional unit 3 may be a sensor or an actuator. The functional unit 3 requires an electrical power supply to perform its tasks. This is provided directly in the automation component 1. The present exemplary embodiment relates to a local energy source 4, such as a battery. The energy source 4 supplies the required energy to the functional unit 3. A switch 5 is inserted into the electrical circuit 6 which is formed by the functional unit and the battery. The switch is an electronic switch, such as a CMOS switch, i.e., a switch comprising a semiconductor element. When the electronic switch 5 is open, the functional unit 3 is not supplied with power. It is in a standby mode, in which the functional unit 3 does not consume any energy. However, in this mode, unit 3 also cannot perform any automation tasks. The automation component 1 furthermore has a passive component, i.e., a passive unit 2. This may be an RFID tag comprising a passive RFID tag. The RFID tag is connected or coupled to the electronic switch 5. When the RFID tag receives a radio signal, then energy is also transmitted to the RFID tag with this radio signal. The passive RFID tag is activated, and the received energy is passed on to the electronic switch 5, by which the switch can be operated. The reception of the radio signal can be used to close the electronic switch 5, and the functional unit 3 of the automation component 1 is then supplied with energy from the battery 4. The entire automation component 1 is now in an active state, and can perform automation tasks. The electronic switch 5 can be opened again by a further radio signal, and the automation component 1 is once again switched to standby operation, in which no energy is consumed. This allows simple activation and deactivation by sending a radio signal and, as seen from the automation component, by reception of a radio signal containing the energy.

In addition to the energy, the radio signal also transmits data to the automation component 1. Here, useful data can be transmitted, or else signals which, in addition to the energy, contain, for example, activation and/or deactivation information, or an identification, for example a tag or a specific automation component, as a result of which the automation component reacts only if its own tag matches the transmitted tag.

FIG. 2 shows a schematic layout of an automation system having two sensor/actuator networks. Here, the networks can different automation tasks. In this case, individual components of the networks N1, N2 are electrical automation components 1_{1 . . . n} which have the described functionality, can be switched to zero-energy standby operation, and can also be activated from this state again by radio signals. In the example, these are the sensor/actuator nodes A to F in a first sensor network N1 and sensor/actuator nodes in a second network N2 in an automation system. In the first sensor/actuator network N1, each node can communicate with every other node, where each sensor is equipped with a sensor/actuator functionality, and has appropriate processing algorithms, depending on the embodiment. Here, power is supplied to the individual nodes by a battery that contains the individual nodes as automation components. By way of example, the nodes A, B, C, D and F are activated in the first sensor/actuator network N1. If it is found that the node E is intended to be activated, then this is activated by one of the other nodes transmitting a radio signal. A node is correspondingly deactivated, or else is deactivated by the node itself. Here, as already explained, the respective sensor/actuator node is switched to a zero-energy standby mode, since it is switched off completely and does not consume any further energy. The processes of switching on and off are only performed by the radio signal from the other nodes, with sufficient energy being available to operate the electronic switch in the node and to activate the main circuit (i.e., the battery and functional unit). The energy required for this purpose is made available by one or more nodes or automation components within range, in the form of electromagnetic waves or magnetic fields (i.e., by inductive coupling). This energy should be made available only until the main circuit is activated, after which each node can be operated autonomously by the local power supply.

FIG. 2 shows a further sensor/actuator network N2, which is not required at a specific time in the automation installation, since it need not perform any automation tasks. For example, a specific network may be relevant only when other networks have virtually or completely performed their work. Here, it is advantageous for the network not to be activated until it is also intended to perform its work. In the example, the second network comprises the nodes H, I, J and K. The system is intended to be activated, with its sensor/actuator nodes, only when the system requires something to also be processed. For this purpose, the system is connected to at least one active node from the sensor/actuator network N1. This node, for example, the node F, then supplies the activation energy for at least one node H in the sensor/actuator network N2. When a node in the second sensor/actuator network N2 is activated, then this can activate the entire system since every activated node can itself interchange radio signals with further nodes and, when these radio signals are transmitted, the required energy can also be provided for further nodes or automation components in the second sensor/actuator network. Once the entire sensor/actuator network has been activated, then the automation task can be performed. When the entire system is no longer required, this can once again be switched to the standby mode. Entire sensor/actuator networks can therefore be activated and deactivated without any action by the system operator. The activation and deactivation occur very quickly, since the radio signals are transmitted without any time delay, and the cascaded activation of a large number of nodes allows an entire sensor/actuator network to be started up quickly. The entire system is energy-efficient since a zero-energy standby state is provided for the automation components, and the maintenance effort for such automation systems is minimized overall.

FIG. 3 shows an example of a circuit diagram for the implementation of an electronic switch 5 comprising a CMOS switch design.

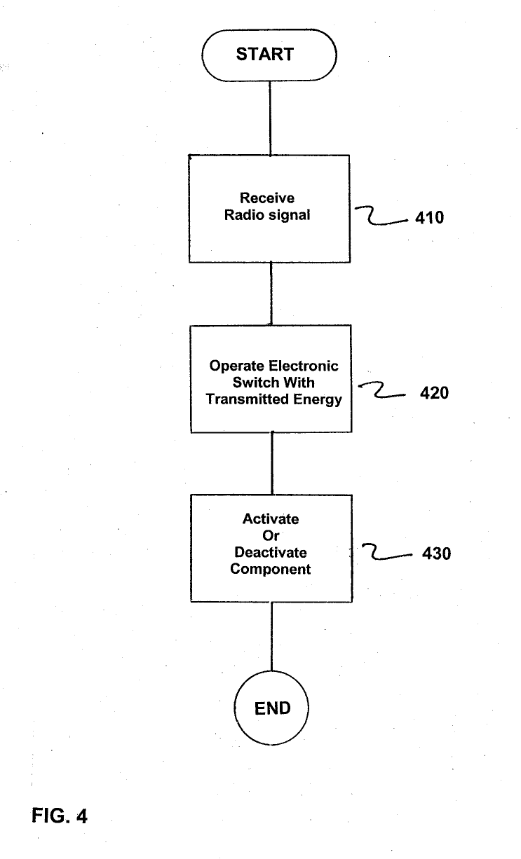

FIG. 4 is a flow chart of a method for radio-based activation and deactivation of zero-energy standby operation of automation component. The method comprises receiving, at a passive unit of the automation component, a radio signal, as indicated in step 410. An electronic switch is operated with energy transmitted with the radio signal, as indicated in step 420.

The operation of the electronic switch interrupts or recreates a power supplied to a functional unit of the automation component such that the functional unit of the automation component is one of activated and deactivated, as indicated in step 430.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-20. (canceled)

21. A method for radio-based activation and deactivation of zero-energy standby operation of automation component, comprising:
receiving, at a passive unit of the automation component, a radio signal; and
operating an electronic switch with energy transmitted with the radio signal;
wherein the operating the electronic switch one of interrupts or recreates a power supplied to a functional unit of the automation component such that the functional unit of the automation component is one of activated and deactivated.

22. The method as claimed in claim 21, wherein the power supplied is one of interrupted and recreated by a CMOS switch.

23. The method as claimed in claim 21, wherein the radio signal is received by a radio frequency identification (RFID) tag.

24. The method as claimed in claim 22, in which the radio signal is received by a radio frequency identification (RFID) tag.

25. The method as claimed in claim 21, wherein the operating the electronic switch one of activates and deactivates sensor/actuator nodes of a sensor network.

26. The method as claimed in claim 21, wherein a specific signal for activation and deactivation of the functional unit is transmitted with the radio signal.

27. The method as claimed in claim 21, wherein an ID is transmitted with the radio signal, and wherein the functional unit is one of activated and deactivated when the transmitted ID matches an ID of the automation component.

28. The method as claimed in claim 21, wherein the automation component sends and receives data by radio as soon as the functional unit is activated.

29. The method as claimed in claim 21, wherein a plurality of automation components communicate with one another by radio signals, and wherein the plurality of automation components activate and deactivate one another by the radio signals.

30. The method as claimed in claim 29, wherein the plurality of automation components comprise a plurality of sensor/actuator nodes forming a sensor/actuator network.

31. The method as claimed in claim 29, wherein the plurality of automation components comprise a plurality of sensor/actuator nodes forming at least two sensor/actuator networks having different automation tasks, and wherein the functional unit of at least one automation component in the second sensor/actuator network is activated by reception of the radio signal from the automation component in a first sensor/actuator network.

32. An electrical automation component comprising:
a passive unit for receiving a radio signal;
a functional unit for performing an automation functionality;
a local power source for supplying power to the functional unit; and
an electronic switch arranged between the power source and the functional unit and configured to activate and deactivate the functional unit;
wherein the electronic switch is coupled to the passive unit and the electronic switch is operable using energy received by the passive unit with the radio signal such that the functional unit of the automation component can be one of activated and deactivated in response to the radio signals.

33. The automation component as claimed in claim 32, wherein the electronic switch comprises a CMOS switch.

34. The automation component as claimed in claim 32, wherein the passive unit is comprises a radio frequency identification (RFID) tag.

35. The automation component as claimed in claim 33, wherein the passive unit comprises a radio frequency identification (RFID) tag.

36. The automation component as claimed in claim 32, wherein the functional unit comprises a sensor/actuator node of a sensor network.

37. The automation component as claimed in claim 32, wherein a specific signal is provided for activation and deactivation of the functional unit, and wherein the specific signal is transmittable with the radio signal.

38. The automation component as claimed in claim 32, wherein the automation component has an ID, and wherein one of activation and deactivation of the functional unit occurs when an ID transmitted with the radio signal matches the ID of the automation component.

39. The automation component as claimed in claim 32, wherein the automation component receives and sends data by radio as soon as the electronic switch is closed and the functional unit is active.

40. A system comprising a plurality of electrical automation components, each of said plural electrical components comprising:
a passive unit for receiving a radio signal;
a functional unit for performing an automation functionality;
a local power source for supplying power to the functional unit; and
an electronic switch arranged between the power source and the functional unit and configured to activate and deactivate the functional unit;
wherein the electronic switch is coupled to the passive unit and the electronic switch is operable using energy received by the passive unit with the radio signal such that the functional unit of the automation component can be one of activated and deactivated in response to the radio signals;
wherein each of the plurality of automation components communicate with one another by radio signals; and
wherein the plurality of radio signals mutually one of activate and deactivate the plurality of automation components.

41. The system as claimed in claim 40, wherein each of the plurality of automation components comprise a sensor/actuator node in a sensor/actuator network.

42. The system as claimed in claim 40, wherein the plurality of automation components comprise sensor/actuator nodes forming at least first and second sensor/actuator networks;
wherein the at least first and second sensor/actuator networks perform different automation tasks; and
wherein the functional unit of at least one automation component in a second sensor/actuator network is activated by reception of the radio signal from an automation component in a first sensor/actuator network.
